(19) United States
(12) Patent Application Publication
(10) Pub. No.: US 2005/0240586 A1
(43) Pub. Date: Oct. 27, 2005

(54) Data processing system for instrumental analysis, server and data processing method

(75) Inventor: Yuko Sakata, Mishima-gun (JP)

Correspondence Address: RANKIN, HILL, PORTER & CLARK LLP, 4080 ERIE STREET, WILLOUGHBY, OH, 44094-7836, US

(73) Assignee: SHIMADZU CORPORATION, Kyoto-shi (JP)

(21) Appl. No.: 11/100,676

(22) Filed: Apr. 7, 2005

(30) Foreign Application Priority Data
Apr. 21, 2004 (JP) 2004-125534

(51) Int. Cl. G06F 17/30

(52) U.S. Cl. 707/8

(57) ABSTRACT

A server receiving instruction of data analysis processing executes the analysis processing, generates a report using the processing result, and then converts the report document into a PDF file and copies the file into a predetermined folder of a PC of the processing instruction source. When an operator instructs print out with a PC at hand, a report of a PDF format is printed out by a function of a printer driver installed in the PC. Thus, the server does not participate in print out processing at all, load is not imposed on the server, and also there is no need for the server to have a printer driver for a printer connected to each of the PCs.

This application claims foreign priority based on Japanese Patent application No. 2004-125534, filed Apr. 21, 2004, the contents of which is incorporated herein by reference in its entirety.

### BACKGROUND OF THE INVENTION

1. Field of the Invention

The present invention relates to a data processing system for instrumental analysis for performing analysis processing of various data obtained by various analyzers (for example, a chromatograph device, a spectrophotometer, a mass spectrometer, etc.) used in instrumental analysis, or storing and managing such data. More particularly, the present invention relates to a server/client type data processing system for instrumental analysis, a server and a data processing method.

2. Description of the Related Art

In recent years, in many cases, a general-purpose personal computer has been used as a controller or a data processor in various analytical instruments such as a chromatograph device or a spectrophotometer. The instruments have been constructed so as to achieve data processing or control for analysis by installing dedicated control/processing software in the computer and executing the software. Furthermore, in the field of instrumental analysis, networking using a LAN (Local Area Network) etc. has bee progressing, and plural analytical instruments are mutually connected and data obtained by analysis is shared.

For example, JP-A-2003-173340 discloses a server/client type data processing system. In this system, a computer having a database function is used as a server, and a computer used by a general user or a computer included in various analyzers is used as a client terminal. In such a system, measured data obtained by various analyzers is stored not only in a storage section of the computer connected to each of the analyzers but also in a database of the server. Each user can read out the data thus stored in the database using the user's own computer, make the data displayed on a display, edit the data or execute another analysis processing.

Generally, in such a data processing system, it is more efficient to receive instructions from each of the client terminals and execute data analysis processing intensively in the server than to perform data analysis processing in the computer of each of the client terminals. Also, it is advantageous in system management since application software for data analysis processing has to be installed only in the server. As a result, it is often configured so that data analysis processing is executed intensively in the server, and further, generation processing or print out processing of a report including the result of its analysis processing is executed intensively in the server.

However, there are following problems in such a data processing system.

(1) In the intensive processing system as described above, as a large load is imposed on the server, it does not matter when the number of client terminals is small, but when the number of client terminals increases, the need to increase processing performance of the server accordingly arises. As a result, an expensive server must be introduced and this leads to the increase in cost.

(2) In the case of performing print out processing in the server, output processing to a network printer is generally performed, and the system is normally built over a plurality of rooms and printers of various models often exit on a network. In that case, printer drivers for various printers must be installed in the server, and printout destinations must be set individually (for every each terminal) in the server. Therefore, for example, when a printer is replaced or added, change in the setting or new installation of the printer driver is required in the server as well as the client terminal to which the printer is connected, and a network (system) administrator has to expend much time and effort and it becomes a large burden on the administrator.

### SUMMARY OF THE INVENTION

The invention is implemented to solve such problems. An object of the invention is to provide a data processing system for instrumental analysis, a server, and a data processing method, in which the server can be released from a load of print out processing to thereby a load on the server can be reduced, even when data analysis processing or the like is intensively performed in a server and a report is generated using the result or the like. Also, another object of the invention is to provide a data processing system for instrumental analysis in which a large burden is not imposed on a network administrator or a system administrator, even when a printer is replaced or added on the client side.

To achieve this objective, the invention includes the following configuration.

A data processing system for an instrumental analysis, the system comprising:
a server which executes a data analysis processing; and
at least one client terminal which controls an analytical instrument for acquiring data and/or instructs the data analysis processing to the server, the client terminal being connected to the server via a network,
wherein the server includes
a report file generating section for executing the data analysis processing based on the instruction from the client terminal, and generating a report file in an image format independent of a printer model, the report file containing a result obtained by the data analysis processing, and
a file copy section for copying the report file to a storage section of the client terminal, and
the client terminal executes a print out processing with respect to the report file stored in the storage section so that the report file is printed out from a printer connected to the client terminal or to which a print out instruction can be given from the client terminal.

For example, when an operator instructs the execution of a predetermined data analysis processing from the client terminal at hand, the server receives the instructions, the report file generating section executes the data analysis processing and generates a report document including the processing result as a file in an image format independent of a printer model. Examples well known as the file in the image format independent of the printer model include a file in a PDF format described by PostScript (registered trademark) which is a page-description language independent of the printer model. Incidentally, the report file generating section may generate a file in a PDF format from the beginning, but, for example, may perform processing of converting into a file in a PDF format etc. after once generating a file in a standard format used in application software for data analysis processing.

When the file in the image format independent of the printer model is generated, the file copy section sends this file to the terminal so as to copy the file in a storage section of the client terminal which instructed the execution of the data analysis processing, in a state of retaining the file in a storage section of the server. As a result of this, a report document including the analysis processing result desired by the operator is stored in the storage section (normally, a hard disk drive) of the client terminal at hand of the operator. Therefore, when print out processing of the report document is executed by this client terminal, the desired report document is printed and outputted from a printer connected to the terminal or another printer capable of giving output instructions from the terminal according to the setting, as a function of a printer driver installed in the terminal.

### BRIEF DESCRIPTION OF THE DRAWINGS

FIG. 1 is the whole configuration diagram showing an embodiment of a data processing system for instrumental analysis according to the invention.

FIG. 2 is a flowchart describing a characteristic operation in the data processing system for instrumental analysis of the embodiment.

### DESCRIPTION OF THE PRFERRED EMBODIMENTS

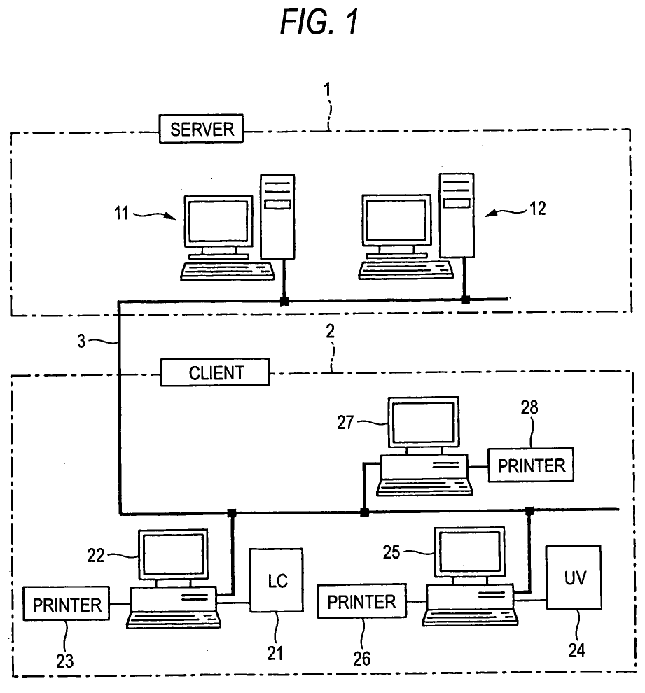

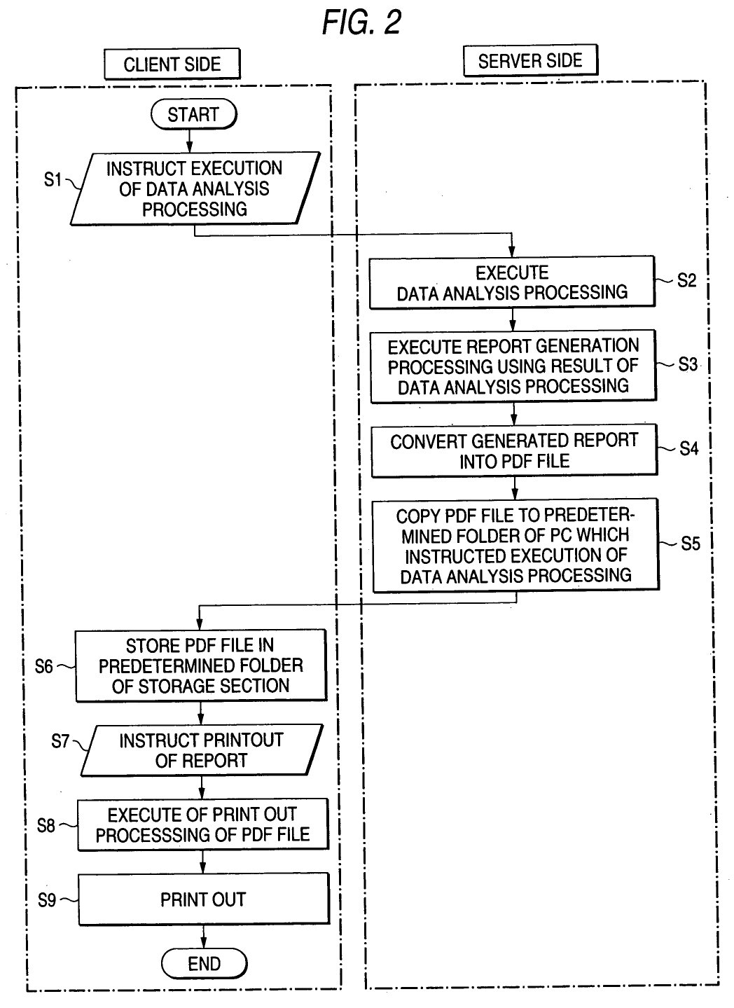

A data processing system for instrumental analysis, which is one embodiment of the invention, will be described below with reference to FIGS. 1 and 2. FIG. 1 is the whole configuration diagram showing one example of a data processing system of the present embodiment, and FIG. 2 is a flowchart describing a characteristic operation in the data processing system of the present embodiment.

The data processing system of the embodiment is constructed of a server/client system with a server 1 as a center. Here, the server 1 includes a database server 11 and an application server 12. Analytical data etc. acquired by each analyzer is sent to the database server 11 so as to be stored into a database in the database server 11 for file sharing. On the other hand, the application server 12 is equipped with application software to perform various data analysis processing concerning instrumental analysis, and the data analysis processing using this software can be executed. Incidentally, proper modifications may naturally be made, for example, the database server 11 and the application server 12 are implemented in the same computer.

A client 2 includes analyzers 21, 24 such as a liquid chromatograph apparatus (LC) and an ultraviolet visible spectrophotometer (UV), computers 22, 25 for respectively controlling these analyzers 21, 24, and an individual computer 27 which is not directly connected to the analyzers, and printers 23, 26, 28 are independently connected to each of the computers (hereinafter abbreviated as PCs) 22, 25, 27 which corresponds to a client terminal in the invention. Here, the PC 27 is disposed as, for example, a terminal for system administrator or a terminal for data viewing or another analysis instruction, but is not naturally limited to such a function. Also, a kind or the number of analyzers and the number of computers, etc. in the client 2 can naturally be changed freely as necessary.

All of the database server 11 and the application server 12 in the server 1 and each of the PCs 22, 25, 27 in the client 2 are connected to a network 3, and data can be sent and received mutually through the network 3. The network 3 here in is a closed local network inside a company introducing this system and typically, the Ethernet (registered trademark) is used.

In the configuration described above, software of printer drivers for controlling the printers 23, 26, 28 connected respectively to the PCs 22, 25, 27 inside the client 2 is installed in each of the PCs 22, 25, 27. As is well known, printer drivers generally differ in every model of the printers, therefore each of the printer drivers also differs when models of the printers 23, 26, 28 differ respectively. In the system of the related art, it was also necessary to install such printer drivers corresponding to each of the printers in the application server 12, but in the data processing system of the embodiment, it is unnecessary to install such printer drivers (naturally, there is no harm even when the installation is performed).

In the data processing system of the embodiment, a characteristic control/processing operation is executed, which is different from the system of the related art, when an operator operates any PC 22, 25 or 27 inside the client 2 to thereby execute desired data analysis processing, and wants to output the result from the printer at hand as a report. Such an operation is achieved by control/processing software installed in the application server 12. The operational procedure and processing operation for this purpose will be described with reference to FIG. 2.

An operator operates the PC at hand, and for example, selects desired analytical data stored in the database server 11 and instructs execution of predetermined data analysis processing with respect to the analytical data (step S1). Here, the case of giving instruction from the PC 27 is assumed as one example. The instruction is sent from the PC 27 to the server 1 through the network 3, and the application server 12 receiving the instruction acquires the necessary analytical data from the database server 11 and executes the data analysis processing with respect to the received analytical data (step S2).

When the data analysis processing is completed, the application server 12 then executes generation processing of a report using the processing result (step S3). In what format the report is generated, that is, a layout etc. in the report can be conformed to a predetermined format, which may be respectively defined by a system administrator or each of the operators (measurer).

When the report is generated, this report document is then converted into an image file format that is independent of a printer model. For example, the report document is converted into a file format described by a code of PostScript (registered trademark) which is one of page description languages, and specifically, it could be converted into a file in a PDF format developed by Adobe Systems Incorporated (step S4). The report in the PDF format thus generated is stored in a predetermined folder in the application server 12.

Subsequently, the file in the PDF format is copied to a predetermined folder in the PC 27 which is a processing instruction source (step S5). That is, the application server 12 recognizes from which PC the instruction is sent from at the time when receiving the instruction of data analysis processing, accordingly the file in the PDF format is sent to the PC which instructed the execution of the data analysis processing through the network 3. In the PC 27, the received file is stored in a predetermined folder (step S6). The folder in which the file is stored can be specified previously.

In the PDF format, a document can be outputted (displayed or printed) by the same layout and the same image under different environment without depending on an application or an operation system (OS) of the PC or a font. Therefore, the application server 12 does not need to consider under which environment the PC of a processing instruction source is at all, and can simply send out the PDF file to the PC.

On the other hand, in the PC 27, as the report document in the PDF file format is stored in the predetermined folder, the operator specifies the file and gives a printout instruction when printing out the report (step S7). When the printout instruction is received, a printer driver installed in the PC 27 activates and print out processing of the PDF file is executed (step S8), and as a result of that, report as a printed paper can be acquired from the printer 28 at hand. Also, in the PDF file, as a report image is recorded in an electronic file format, the operator can check the report on a screen of the operator's own PC without giving printout instruction (step S9).

As is evident from the above description, in the data processing system, while data analysis processing is intensively executed on the server 1 side, print out processing of a report generated as a result of the processing is executed on the client 2 side, that is, each of the Pcs that gives the instruction of the data analysis processing, and the server 1 side does not participate in the print out processing. Execution of the print out processing may impose a considerable load on the computer, but in the data processing system of the embodiment, print out processing is not executed in the application server 12, so that a load can be reduced particularly even when plural data analysis processing overlaps. Also, as described above, it is unnecessary to install a printer driver for a printer connected to each of the PCs in the application server 12, and installation of a printer driver for a printer connected to the PC is performed in every PC to which the printer is connected, so that the system can be easily managed, for example, even when a printer is replaced or added, etc.

According to a data processing system for instrumental analysis according to the invention, the following effects are obtained.

(1) While data analysis processing or report generation processing is performed in a server, the server does not execute print out processing at all and each of the client terminals respectively takes charge of the print out processing, accordingly a processing load of the server can be reduced. Therefore, even when the number of client terminals is increased, there is no need to increase processing performance of the server necessarily and an increase in cost of the whole system can be decreased. Also, by reducing the load of the server, a processing performance of the server is stabilized and trouble such as undesirable freeze can be avoided.

(2) Since a print out destination of a report is conformed to the setting in each of the client terminals, the report can be printed out from a desired printer freely according to the setting in each of the client terminals by an operator without being printed out to a printer set in the server side as in the related art.

(3) Since installation of a printer driver could be performed in individual client terminal, even when a printer is replaced or added, a change in the setting or the installation of the printer driver is unnecessary in the server side and a network administrator or a system administrator is not bothered.

Incidentally, the embodiment described above is one example of the invention, and the invention of the present application obviously includes proper changes, modifications, additions, etc. within the scope of the gist of the invention.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A data processing system for an instrumental analysis, said system comprising:
a server which executes a data analysis processing; and
at least one client terminal which controls an analytical instrument for acquiring data and/or instructs the data analysis processing to said server, said client terminal being connected to said server via a network,
wherein said server includes
a report file generating section for executing the data analysis processing based on the instruction from the client terminal, and generating a report file in an image format independent of a printer model, said report file containing a result obtained by the data analysis processing, and
a file copy section for copying the report file to a storage section of the client terminal, and
said client terminal executes a print out processing with respect to the report file stored in the storage section so that the report file is printed out from a printer connected to said client terminal or to which a print out instruction can be given from said client terminal.

2. A data processing system for an instrumental analysis according to claim 1, wherein said system comprises a plurality of client terminals connected to said server via the network, each of which controls an analytical instrument for acquiring data and/or instructs the data analysis processing to said server,
wherein the report file generating section of said server executes the data analysis processing based on the instruction from the client terminal and generates a report file in an image format independent of a printer model, said report file containing a result obtained by the data analysis processing, and the file copy section of said server copies the report file to a storage section of the client terminal which instructed the execution of the data analysis processing, and
wherein the client terminal which instructed the execution of the data analysis processing executes a print out processing with respect to the report file stored in the storage section so that the report file is printed out from a printer connected to the client terminal which instructed the execution of the data analysis processing or to which a print out instruction can be given from the client terminal which instructed the execution of the data analysis processing.

3. A server for executing a data analysis processing for an instrumental analysis, said server comprising:
a report file generating section for executing the data analysis processing based on the instruction from a client terminal connected to said server via a network, and generating a report file in an image format independent of a printer model, said report file containing a result obtained by the data analysis processing, and
a file copy section for copying the report file to a storage section of the client terminal.

4. A data processing method, comprising:
executing a data analysis processing based on an instruction from a client terminal which is connected to a server via a network;
executing a report generation processing using a result of the data analysis processing to generate a report containing a result obtained by the data analysis processing;
converting the generated report into a file in an image format independent of a printer model; and
copying the file to a storage section of the client terminal which instructed the execution of the data analysis processing.
